(19) United States
(12) Patent Application Publication
(10) Pub. No.: US 2006/0012688 A1
(43) Pub. Date: Jan. 19, 2006

(54) Apparatus and method for generating control signals to regulate gain levels of color signals

(75) Inventor: Sung-Jin Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/168,762

(22) Filed: Jun. 29, 2005

(30) Foreign Application Priority Data
Jul. 15, 2004 (KR) 2004-55009

(51) Int. Cl. H04N 9/73

(52) U.S. Cl. 348/223.1

(57) ABSTRACT

An apparatus and method for generating control signals to regulate gain levels of color signals based on color data of which color gains are not regulated and color data of which color gains are regulated. The apparatus and method include generating first control signals to regulate the gain levels of the plurality of color signals based on a plurality of color signals of which gain levels are not regulated, calculating correction values to correct the first control signals based on a plurality of color signals of which gain levels are regulated, and generating second control signals which are results of correcting the first control signals by the correction values.

### CROSS-REFERENCE TO RELATED APPLICATIONS

This application claims the benefit under 35 U.S.C. § 119(a) from Korean Patent Application No. 2004-55009, filed on Jul. 15, 2004 with the Korean Intellectual Property Office, the entire disclosure of which is incorporated herein by reference.

### BACKGROUND OF THE INVENTION

1. Field of the Invention

The present invention generally relates to an apparatus and method for generating control signals to regulate gain levels of color signals and a method thereof. More specifically, the present invention relates to an apparatus and method for generating control signals to regulate gain levels of color signals and a method thereof, wherein a white balance control, which is typically obtained by relatively regulating gain levels of color signals, is adapted to an image pickup apparatus such as a video camera or a digital still camera, so that a ‘white’ object appears white.

2. Description of the Related Art

A conventional white balance control method regulates the balance of color components of red (R), green (G), and blue (B) of each pixel signal (that is, three primary color components of red, green and blue) average out the imbalances to make the entire image achromatic, as disclosed in U.S. Pat. No. 5,038,205, which is incorporated herein by reference.

Another general conventional white balance control method, which is disclosed in U.S. Patent Publication No. 2002/0101516, which is incorporated herein by reference receives RGB data from a color separation circuit and calculates R-gain and B-gain based on the received data in accordance with the following equations:
R−gain=(R−gain_Auto×k+R−gain_{—}hi×(10−k))/10
B−gain=(B−gain_Auto×k+B−gain_{—}hi×(10−k))/10.

In the above equations, k is a weight parameter, R−gain_Auto is set regardless of luminance (Y), and R−gain_hi is set based on luminance (Y) information. Accordingly, more accurate white balance control is achieved with respect to the object of low luminance by adjusting the weight parameter.

Still another white balance method, which is disclosed in U.S. Pat. No. 5,267,026, which is incorporated herein by reference receives color difference signals R−Y and B−Y included in amplified color data and controls the white balance according to a certain process if the received color difference signals are not equal to zero when it is determined that the white balance is not correct.

The above conventional method of U.S. Patent Publication No. 2002/0101516 achieves the white balance control of the color data using the control signals for the white balance control computed based on the color data which is not yet input to the color signal amplifier. However, such a method cannot confirm whether the controlled white balance is properly obtained.

The aforementioned conventional method of U.S. Pat. No. 5,267,026 achieves the white balance control of the color data using the control signals for the white balance control computed based on the color data output from the color signal amplifier. However, since the control signals are output based on the color data of which white balance is controlled already, it is likely to make a wrong determination with respect to the non-white region as the white region, or vice versa Therefore, there is a need for a white balance control that accurately determines the non-white and the white regions of an image.

### SUMMARY OF THE INVENTION

To overcome the above disadvantages of the conventional arrangements, an aspect of the present invention provides a method for generating control signals to regulate gain levels of color signals so as to obtain a white balance control of high accuracy.

Another aspect of the present invention provides an apparatus for generating control signals to regulate gain levels of color signals so as to obtain accurate white balance control.

Consistent with the above aspects of the present invention, a method for generating control signals Rg and Bg which regulate gain levels of a plurality of color signals to maintain white balance of an object by receiving image data comprising the plurality of color signals from the object and regulating the gain levels of the plurality of color signals. The method comprises the steps of generating first control signals to regulate the gain levels of the plurality of color signals based on a plurality of color signals of which gain levels are not regulated, calculating correction values to correct the first control signals based on a plurality of color signals of which gain levels are regulated, and generating second control signals which are results of correcting the first control signals by the correction values.

The second control signals are generated by subtracting the correction values from the first control signals

The correction values are calculated so that the plurality of color signals of which the gain levels are regulated, are placed on a blackbody radiation curve CBL formed by values obtained when a white object is captured under various color temperatures on a two-dimensional plane. The two-dimensional plane has one axis of a ratio IR_{OUT}/IG_{OUT} of a green integrated value IG_{OUT} and a red integrated value IR_{OUT} and the other axis of a ratio IB_{OUT}/IG_{OUT} of the green integrated value IG_{OUT} and a blue integrated value IB_{OUT}.

The correction values are calculated so that the plurality of color signals of which the gain levels are regulated, are placed on a blackbody radiation curve CBL formed by values obtained when a white object is captured under various color temperatures on a two-dimensional plane. The two-dimensional plane has one axis of a red color difference signal R−Y_{OUT} and the other axis of a blue color difference signal B−Y_{OUT}.

The correction values are calculated in reference to a lookup table having correction values determined experimentally according to the plurality of color signals of which the gain levels are regulated.

The correction values of the lookup table are determined experimentally according to values of red, green and blue.

The correction values of the lookup table are determined experimentally according to values of a red color difference signal R−Y, a blue color difference signal B−Y and a luminance signal Y.

The generation of first control signals Rg₁ and Bg₁ comprises sub-steps of dividing the image data into a plurality of regions and calculating a red integrated value IR_{IN}, a green integrated value IG_{IN} and a blue integrated value IB_{IN} by the plurality of regions, calculating a ratio IR_{IN}/IG_{IN} of the green integrated value IG_{IN} and the red integrated value IR_{IN} and a ratio IB_{IN}/IG_{IN} of the green integrated value IG_{IN} and the blue integrated value IB_{IN}, selecting from the plurality of regions a certain region of which the calculated ratios are within a predetermined range, calculating average values IR_{AV,IN}, IG_{AV,IN} and IB_{AV,IN} of the red integrated value IR_{IN}, the green integrated value IG_{IN} and the blue integrated value IB_{IN} with respect to the selected region, and obtaining the first control signals Rg₁ and Bg₁ from the following equation when there is at least one selected region:
Rg₁=1/(IR_{AV,IN}/IG_{AV,IN})
Bg₁=1/(IB_{AV,IN}/IG_{AV,IN})
and setting the first control signals to previous first control signals when there is no selected region.

The predetermined range comprises a blackbody radiation curve formed by values obtained when a white object is captured under various color temperatures on a two-dimensional plane. The two-dimensional plane has one axis of a ratio IR_{IN}/IG_{IN} of the green integrated value IG_{IN} and the red integrated value IR_{IN} and the other axis of a ratio IB_{IN}/IG_{IN} of the green integrated value IG_{IN} and the blue integrated value IB_{IN}.

Still consistent with the above aspect of the present invention, an apparatus for generating control signals Rg and Bg which regulate gain levels of a plurality of color signals to maintain white balance of an object by receiving image data comprising the plurality of color signals from the object and regulating the gain levels of the plurality of color signals. The apparatus comprises means for generating first control signals to regulate the gain levels of the plurality of color signals based on a plurality of color signals of which gain levels are not regulated, means for calculating correction values to correct the first control signals based on a plurality of color signals of which gain levels are regulated, and means for generating second control signals which are results of correcting the first control signals by the correction values.

The means for generating the second control signals obtains the second control signals by subtracting the correction values from the first control signals.

The means for calculating the correction values calculates correction values so that the plurality of color signals of which the gain levels are regulated, are placed on a blackbody radiation curve CBL formed by values obtained when a white object is captured under various color temperatures on a two-dimensional plane. The two-dimensional plane has one axis of a ratio IR_{OUT}/IG_{OUT} of a green integrated value IG_{OUT} and a red integrated value IR_{OUT} and the other axis of a ratio IB_{OUT}/IG_{OUT} of the green integrated value IG_{OUT} and a blue integrated value IB_{OUT}.

The means for calculating the correction values calculates the correction values so that the plurality of color signals of which the gain levels are regulated are placed on a blackbody radiation curve CBL formed by values obtained when a white object is captured under various color temperatures on a two-dimensional plane. The two-dimensional plane has one axis of a color difference signal R−Y_{OUT} and the other axis of a color difference signal B−Y_{OUT}.

The means for calculating the correction values calculates the correction values in reference to a lookup table having correction values determined experimentally according to the plurality of color signals of which the gain levels are regulated.

### BRIEF DESCRIPTION OF THE DRAWING FIGURES

These and/or other aspects and advantages of the invention will become apparent and more readily appreciated from the following description of exemplary embodiments, taken in conjunction with the accompanying drawing figures of which:

FIG. 1 is a block diagram of an image pickup apparatus having control signals generation apparatus for regulating gain levels of color signals according to an embodiment of the present invention;

FIG. 2A is a diagram of a white tracking range according to an embodiment of the present invention;

FIG. 2B is a diagram of a white tracking range according to an embodiment of the present invention;

FIG. 3 is a flowchart of a method for generating control signals to regulate gain levels of color signals according to an embodiment of the present invention;

FIG. 4 is a flowchart illustrating first control signals are generated according to an embodiment of the present invention;

FIG. 5 is a flowchart illustrating first control signals are generated according to an embodiment of the present invention;

FIG. 6 is a flowchart illustrating first control signals are generated according to an embodiment of the present invention; and

FIG. 7 is a flowchart illustrating correction values are determined to correct the first control signals according to an embodiment of the present invention.

Throughout the drawings, the same or similar elements are denoted by the same reference numerals.

### DETAILED DESCRIPTION OF EXEMPLARY EMBODIMENTS

Reference will now be made in detail to the embodiments of the present invention, examples of which are illustrated in the accompanying drawings. The embodiments are described below in order to explain the present invention by referring to the drawings.

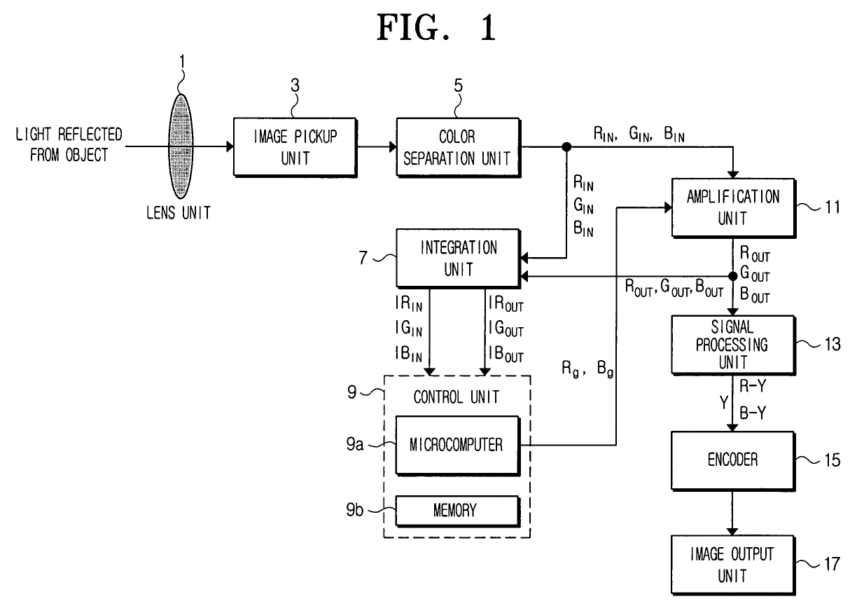

FIG. 1 illustrates an image pickup apparatus having a control signal generation apparatus for regulating gain levels of color signals according to an embodiment of the present invention.

Referring to FIG. 1, the image pickup apparatus comprises a lens unit 1, an image pickup unit 3, a color separation unit 5, an integration unit 7, a control unit 9, an amplification unit 11, a signal processing unit 13, an encoder 15, and an image output unit 17.

The lens unit 1 comprises an optical lens, an aperture, and a mechanical shutter, which are driven according to respective control signals supplied externally to adjust a focal length and an amount of exposure.

The image pickup unit 3 comprises a color charge-coupled device (CCD) and a correlated double sampling (CDS) circuit. The image pickup unit 3 receives light through the lens unit 1 and converts the received light into an analog signal.

Although not shown in FIG. 1, an analog-to-digital (A/D) converter is disposed between the image pickup unit 3 and the color separation unit 5. The A/D converter converts the analog signal from the image pickup unit 3 into a digital signal.

The color separation unit 5 comprises an arrangement of color filters of the CCD, and separates the digital signal received from the A/D converter by colors. According to an embodiment of the present invention, the color separation unit 5 separates the digital signal into three signals of red (R), green (G) and blue (B).

The amplification unit 11 increases or decreases magnitude of color signals input from the color separation unit 5 according to control signals input from the control unit 9. According to an embodiment of the present invention, the amplification unit 11 comprises a R amplifier having a gain Rg to amplify a R signal and a B signal, respectively, and a B amplifier having a gain Bg. The amplification unit 11 decreases or increases the magnitude of the R signal and the B signal in accordance with Rg and Bg values. Color signals input to the amplification unit 11 are presented as R_{IN}, G_{IN} and B_{IN}, respectively, and color signals output from the amplification unit are presented as R_{OUT}, G_{OUT} and B_{OUT}, respectively.

If the signal processing unit 13 is a single-plate type, the signal processing unit 13 performs color interpolation. According to an embodiment of the present invention, the signal processing unit 13 receives R_{OUT}, G_{OUT} and B_{OUT} and outputs a luminance value Y and color difference signals R−Y and B−Y. It is well-known how to calculate the luminance value Y and the color difference signals R−Y and B−Y from the R, G and B color signals, which may be obtained in accordance with the following equations:
Y=0.3×R+0.6×G+0.1×B
R−Y=0.7×R−0.6×G−0.1×B
B−Y=−0.3×R−0.6−G+0.9×B.

The image output unit 17 is an image display device or a memory for recording image data. Light reflected from an object is subjected to the above-mentioned operations and is finally output to the image output unit 17 as image data in a visible format such as a photograph.

The integration unit 7 receives the color signals R_{IN}, G_{IN} and B_{IN} from the color separation unit 5 and calculates integrated values IR_{IN}, IG_{IN} and IB_{IN}, respectively for the received color signals.

The control unit 9 controls the entire image pickup apparatus, and controls color gains of the amplification unit 11 to maintain the white balance of the object. In capturing an image, the control unit 9 sends control signals to the lens unit 1, and a timing control signal for synchronizing the image data to the signal processing unit 13. The control unit 9 calculates and sends color signal gain level control signals Rg and Bg to the amplification unit 11. The control unit 9 sends an image display control signal or an image recording control signal to the image output unit 17. According to an embodiment of the present invention, the control unit 9 comprises a microcomputer 9a and a memory 9b. The microcomputer 9a performs operations to generate the control signals explained above. The memory 9b comprises data and control programs required for the microcomputer 9a to calculate the control signals. The memory 9b may comprise a random access memory (RAM) and a read only memory (ROM), which are not shown.

In FIG. 1, the color signals of R_{IN}, G_{IN} and B_{IN}, the color signals of R_{OUT}, G_{OUT} and B_{OUT}, the color signals of IR_{IN}, IG_{IN} and IB_{IN}, the color signals of IR_{OUT}, IG_{OUT} and IB_{OUT}, the color signals of Y, R−Y and B−Y, and the control signals Rg and Bg, respectively, are input and output along one line. Alternatively, these signals can be input and output along the individual lines.

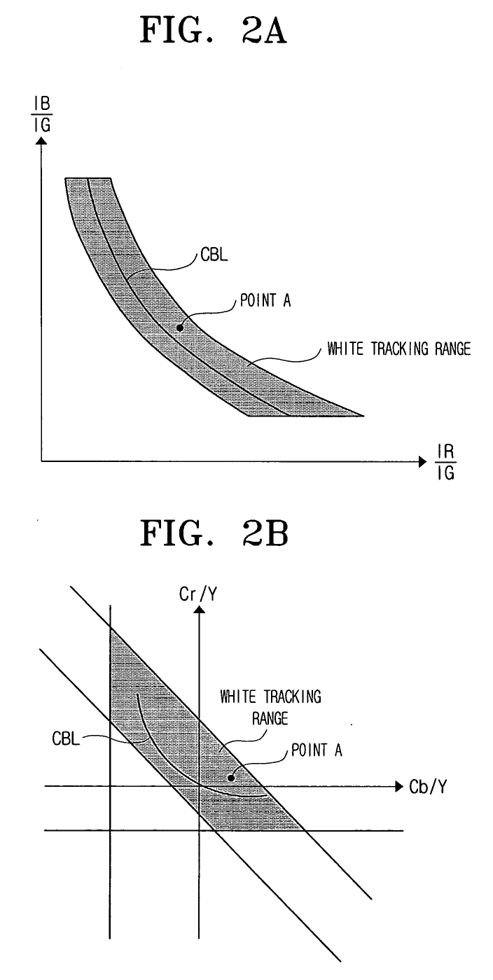

It is described below that the control unit 9 generates the control signals for regulating gain levels of the color signals of the amplification in reference to FIGS. 2 through 7.

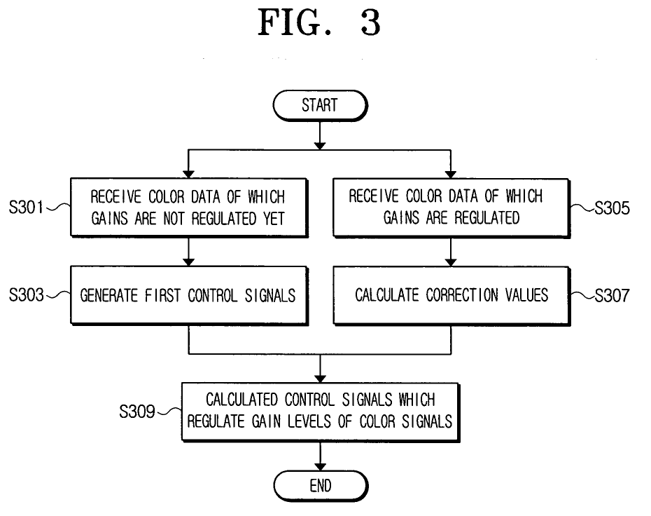

FIG. 3 is a flowchart of a method for generating the control signals to regulate the gain levels of the color signals according to an embodiment of the present invention.

Referring to FIG. 3, the integration unit 7 receives the color data R_{IN}, G_{IN} and B_{IN}, of which gains are not adjusted yet, and calculates certain values at step S301. In this embodiment of the present invention, the color data R_{IN}, G_{IN} and B_{IN} are received, and integrated values IR_{IN}, IG_{IN} and IB_{IN}, respectively for the received color data are calculated. Alternatively, color data of a luminance YIN and color difference values R−Y_{IN} and B−Y_{IN} is received and integrated values may be calculated respectively for Y_{IN}, R−Y_{IN} and B−Y_{IN}.

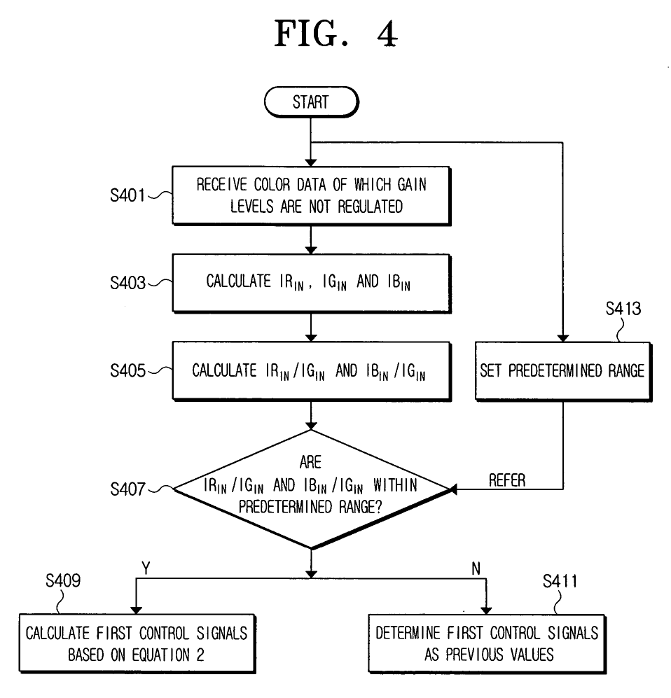

The control unit 9 generates first control signals based on the calculated values at step S303. Referring to FIGS. 4 through 6, the generation of the first control signals will be explained below.

The integration unit 7 receives the color data R_{OUT}, G_{OUT} and B_{OUT}, of which gains are adjusted, and calculates certain values at step S305. Step S305 is similar to step S301. Alternatively, the color data having the adjusted gains may be the color difference signals such as R−Y, B−Y and Y.

Correction values ΔR and ΔB to correct the first control signals are calculated based on the received color data of step S305, at step S307. The correction values, for example, may be pre-stored in the form of a lookup table in the memory 9b. Exemplary lookup tables are presented as the following Table 1 and Table 2.

TABLE 1

| R-Y | B-Y | Luminance (Y) | ΔR | ΔB |
|---|---|---|---|---|
| R-Y_{OUT, 1} | B-Y_{OUT, 1} | Y_{OUT, 1} | ΔR₁ | ΔB₁ |
| R-Y_{OUT, 2} | B-Y_{OUT, 2} | Y_{OUT, 2} | ΔR₂ | ΔB₂ |
| R-Y_{OUT, 3} | B-Y_{OUT, 3} | Y_{OUT, 3} | ΔR₃ | ΔB₃ |
| R-Y_{OUT, 4} | B-Y_{OUT, 4} | Y_{OUT, 4} | ΔR₄ | ΔB₄ |

In Table 1, correction values ΔR₁, ΔR₂, ΔR₃, ΔR₄, ΔB₁, ΔB₂, ΔB₃ and ΔB₄ can be obtained, without undue experimentation, according to the color difference signals R−Y and B−Y and the luminance signal Y.

For instance, if the received data at step S305 are R−Y_{OUT,2}, B−Y_{OUT,2} and Y_{OUT,2}, correction values are determined to ΔR₂ and ΔB₂, respectively.

TABLE 2

| R | G | B | ΔR | ΔB |
|---|---|---|---|---|
| R_{OUT, 1} | G_{OUT, 1} | B_{OUT, 1} | ΔR₁ | ΔB₁ |
| R_{OUT, 2} | G_{OUT, 2} | B_{OUT, 2} | ΔR₂ | ΔB₂ |
| R_{OUT, 3} | G_{OUT, 3} | B_{OUT, 3} | ΔR₃ | ΔB₃ |
| R_{OUT, 4} | G_{OUT, 4} | B_{OUT, 4} | ΔR₄ | ΔB₄ |

In Table 2, correction values ΔR₁, ΔR₂, ΔR₃, ΔR₄, ΔB₁, ΔB₂, ΔB₃ and ΔB₄ can be obtained, without undue experimentation, according to R, G and B values.

Referring now to FIGS. 2A and 2B, the calculation of the correction values to be assigned to the lookup table is explained below.

It is assumed that the received data at step S305 is located at a point A of FIG. 2A. Correction values ΔR and ΔB for the point A are amounts determined so as to move the point A onto a blackbody radiation curve CBL. Specifically, the correction values ΔR and ΔB become a function with respect to a distance from the point A to the curve CBL of FIG. 2A, and may be determined experimentally. According to an embodiment of the present invention, the correction values ΔR and ΔB may be positive or negative. For example, if the received data at step S305 is located over the blackbody radiation curve CBL of FIG. 2A, correction values become positive. In contrary, if the received data is located below the curve CBL, correction values ΔR and ΔB become negative.

Suggested that the received data at step S305 is located at a point A of FIG. 2B, correction values ΔR and ΔB are amounts determined so as to move the point A onto the blackbody radiation curve CBL, and may be positive or negative. Whether the correction value ΔR and ΔB is positive or negative depends on the definition of Equation 1, to be explained below. In case of Equation 1, when the received data at step S305 is located over the curve CBL of FIG. 2B, the correction values ΔR and ΔB become positive. In contrary, the received data is located below the curve CBL, the correction values ΔR and ΔB become negative.

Second control signals for regulating gain levels of the color data are calculated based on the correction values and the first control signals at step S309. The second control signals can be obtained by subtracting the correction values ΔR and ΔB from the first control signals in accordance with
Rg=Rg₁−ΔR
Bg=Bg₁−ΔB Equation 1:

Alternatively, the second control signals can be obtained by adding the first control signals and the correction values. In this case, the positive and negative of the correction values are defined as below. That is, when the received data at step S305 is located over the blackbody radiation curve CBL of FIG. 2, the correction values become negative. When the received data is below the curve CBL, the correction values become positive.

If the correction values are equal to zero, the first control signals is used as it is, without correction, to regulate gain levels of the color data.

The description the second control signals are obtained by subtracting the correction values from the first control signal, for understanding is exemplary and should not be seen as a limitation of the present invention. For example, the second control signals may be generated by multiplying the first control signals by the correction values, in which the correction values are values multiplied by a proper scaling factor.

FIG. 4 is a flowchart of a method for generating first control signals according to an embodiment of the present invention.

Referring to FIG. 4, the color data is received at step S401. The color data comprises R_{IN}, G_{IN} and B_{IN}.

Integrated values IR_{IN}, IG_{IN} and IB_{IN} are calculated for R_{IN}, G_{IN} and B_{IN} at step S403. According to an embodiment of the present invention, the integrated values are calculated for each of the color components with respect to the entire data received.

A ratio IR_{IN}/IG_{IN} and a ratio IB_{IN}/IG_{IN} are calculated at step S405.

Steps S401 through S405 are performed at step S301 described above.

It is determined whether the ratios IR_{IN}/IG_{IN} and IB_{IN} fall within a predetermined range which is defined at step S413, at step S407.

If so, the first control signals are calculated in accordance with following Equation 2 at step S409:
Rg₁=1/(IR_{IN}/IG_{IN})
Bg₁=1/(IB_{IN}/IG_{IN}) Equation 2:

In Equation 2, Rg, is the first control signal with respect to R, and Bg, is the first control signal for B.

When it is determined that the ratios IR_{IN}/IG_{IN} and IB_{IN}/IG_{IN} fall outside the predetermined range, the first control signals for R and B are maintained at the previous values, without changing at step S411.

The predetermined range is set at step S413. The setting of the predetermined range is described in reference to FIGS. 2A and 2B. The hatched area of FIGS. 2A and 2B is the predetermined range where the white is tracked. CBL indicates the blackbody radiation curve. The blackbody radiation curve is constructed by calculating IR/IG and IB/IG from color values obtained by capturing a white object under a light source having various color temperatures and placing the obtained values along one axis of IR/IG and the other axis of IB/IG on a two-dimensional plane.

The white tracking range can be provided to cover a region from the blackbody radiation curve to a certain distance, as shown in FIG. 2A.

FIG. 2B illustrates a white tracking range when the color data comprises the luminance Y and the color difference signals R−Y and B−Y. Cr is data digitized from R−Y, and Cb is data digitized from B−Y.

The predetermined range, that is, the white tracking range can be pre-stored in the memory 9b according to an embodiment of the present invention.

It is determined whether IR_{IN}/IG_{IN} and IB_{IN}/IG_{IN} calculated at step S405 are within the white tracking region of FIG. 2A at step S407.

Referring back to FIG. 4, the first control signals can be obtained from the color components R_{IN}, G_{IN} and B_{IN}, and also may be calculated based on R−Y_{IN}/Y_{IN} and B−Y_{IN}/Y_{IN}. In this situation, the white tracking range as shown in FIG. 2B can be used.

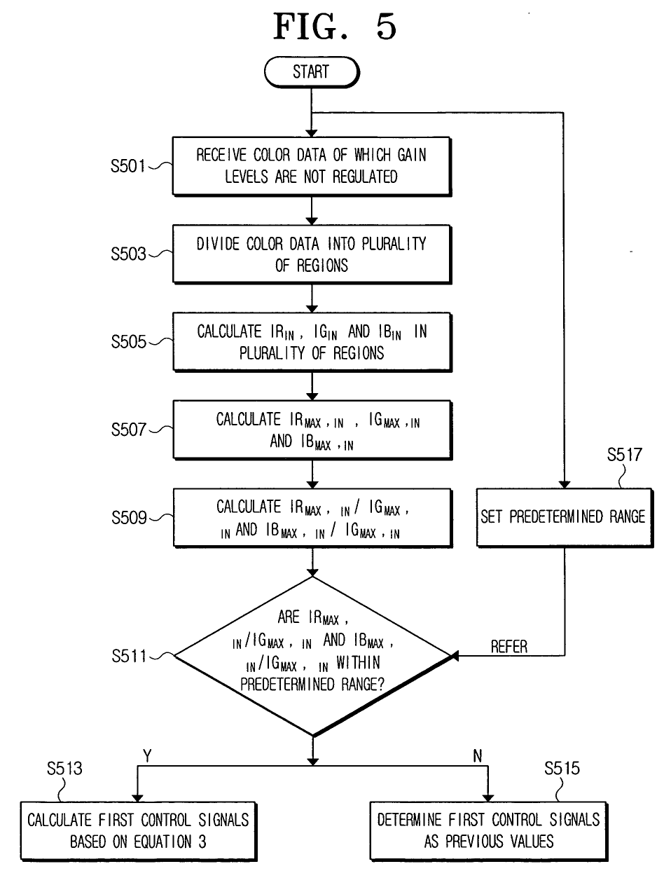

FIG. 5 is a flowchart of a method for determining the first control signals according to an embodiment of the present invention.

The color data is received, of which gain levels are not regulated, at step S501.

The color data is divided into a plurality of regions (for example, a1, a2 . . . , aN) at step S503.

Integrated values IR_{IN}, IG_{IN} and IB_{IN} of the color data are calculated within the plurality of regions at step S505. As the integrated value IR_{IN} is obtained from the plurality of the regions, the total number of integrated values is N. In the same manner, the number of the integrated values IG_{IN} and IB_{IN} is N, respectively.

A maximum value is obtained from the integrated values for the respective colors at step S507. More specifically, IR_{MAX,IN} having the largest value among the N-ary IR_{IN} values is obtained, and IG_{MAX,IN} and IB_{MAX,IN} are obtained for each of IG_{IN} and IB_{IN} in such a manner.

IR_{MAX,IN}/IG_{MAX,IN} and IB_{MAX,IN}/IG_{MAX,IN} are calculated at step S509.

Steps S503 through S509 can be performed at step S301.

It is determined whether IR_{MAX,IN}/IG_{MAX,IN} and IB_{MAX,IN}/IG_{MAX,IN} lie within a predetermined range which is defined at step S517, that is, lie within the hatched area of FIG. 2A at step S511.

If so, the first control signals are calculated in accordance with the following Equation 3 at step S513:
Rg₁=1/(IR_{MAX,IN}/IG_{MAX,IN})
Bg₁=1/(IB_{MAX,IN}/IG_{MAX,IN}). Equation 3:

If it is determined that IR_{MAX,IN}/IG_{MAX,IN} and IB_{MAX,IN}/IG_{MAX,IN} lie outside the predetermined range, the first control signals are determined to be the previous value at step S515.

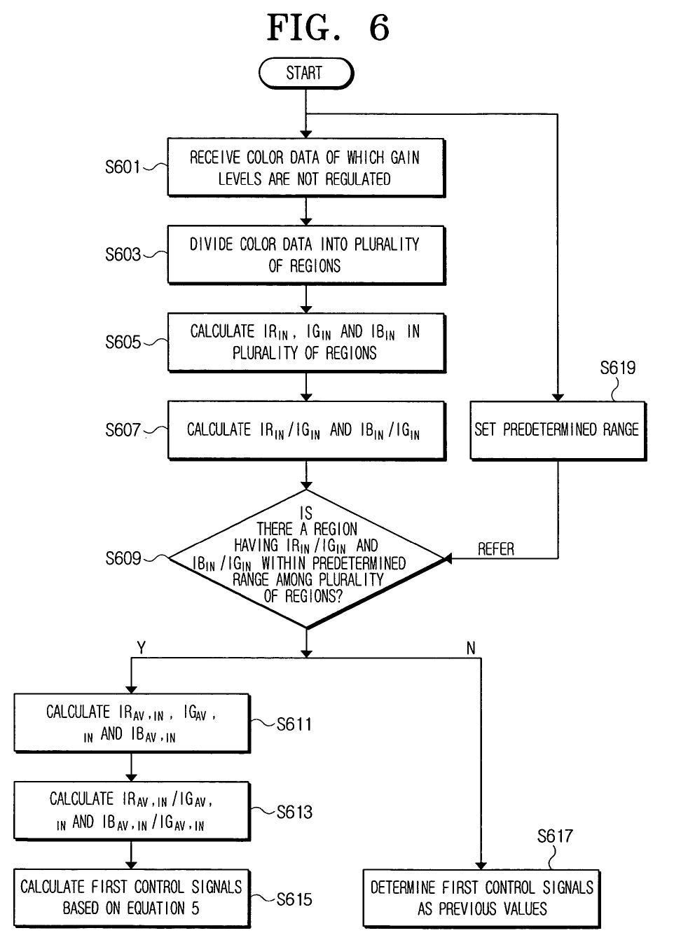

FIG. 6 is another flowchart illustrating the first control signals that are generated according to an embodiment of the present invention.

Steps S601 through S605 are performed in the same manner as steps S501 through S505 of FIG. 5. Therefore, a discussion of steps S601 through S605 will not be provided.

IR_{IN}/IG_{IN} and IB_{IN}/IG_{IN} are calculated with respect to a plurality of regions at step S607. If the total number of the regions is N, IR_{IN}/IG_{IN} and IB_{IN}/IG_{IN} are calculated for each of the N-ary regions.

A value within a predetermined range is selected from the calculated IR_{IN}/IG_{IN} and IB_{IN}/IG_{IN} values at step S609. Specifically, a region having IR_{IN}/IG_{IN} and IB_{IN}/IG_{IN} values within the predetermined range defined at step S619 is selected. According to an embodiment of the present invention, the region having IR_{IN}/IG_{IN} and IB_{IN}/IG_{IN} values within the white tracking range of FIG. 2A is selected.

When there is at least one region having IR_{IN}/IG_{IN} and IB_{IN}/IG_{IN} values within the predetermined range, average values IR_{AV,IN}, IG_{AV,IN} and IB_{AV,IN} of IR_{IN}, IG_{IN} and IB_{IN} with respect to the selected region are calculated at step S611. It is exemplified that the plurality of the regions are a1, a2, . . . , aN and three regions a2, a4 and a7 having IR_{IN}/IG_{IN} and IB_{IN}/IG_{IN} values within the predetermined range of step S619 are selected. The average values are calculated in accordance with the following equation 4 at step S611:
IR_{AV,IN}=(IR_{a2,IN}+IR_{a4,IN}+IR_{a7,IN})/3
IG_{AV,IN}=(IG_{a2,IN}+IG_{a4,IN}+IG_{a7,IN})/3
IB_{AV,IN}=(IB_{a2,IN}+IB_{a4,IN}+IB_{a7,IN})/3 Equation 4:

In Equation 4, IR_{a2,IN}, IG_{a2,IN} and IB_{a2,IN} are color components in the region a2, IR_{a4,IN}, IG_{a4,IN} and IB_{a4,IN} are color components in the region a4, and IR_{a7,IN}, IG_{a7,IN} and IB_{a7,IN} are color components in the region a7.

IR_{AV,IN}/IG_{AV,IN} and IB_{AV,IN}/IG_{AV,IN} are calculated at step S613.

The first signals Rg₁ and Bg₁ are calculated in accordance with the following Equation 5 at step S615:
Rg₁=1/(IR_{AV,IN}/IG_{AV,IN})
Bg₁=1/(IB_{AV,IN}/IG_{AV,IN}) Equation 5:

When there is no region having IR_{IN}/IG_{IN} and IB_{IN}/IG_{IN} within the predetermined range, the first control signals are determined to be the previous value at step S617.

The method for generating the first control signals according to an embodiment of the present invention is illustrated by way of example. U.S. Pat. No. 5,038,205, U.S. Patent Publication No. 2003/0218677, U.S. Pat. No. 6,522,353 and U.S. Patent Publication No. 2002/0201516, all of which are incorporated herein by reference, disclose methods for generating the control signals based on the received color data of which gains are not adjusted

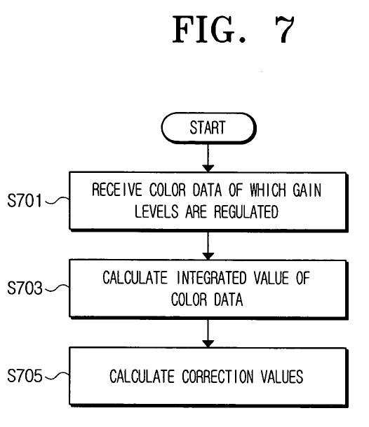

FIG. 7 is a flowchart illustrating that correction values are determined to correct the first control signals according to an embodiment of the present invention.

Referring to FIG. 7, color data of which gain levels are regulated is received at step S701.

Integrated values of the received color data are calculated at step S703. The integrated values may be calculated with respect to a plurality of regions and for R, B and G. Alternatively, integrated values of R−Y, B−Y and Y can be calculated.

Correction values are obtained in reference to a lookup table at step S705. An exemplary lookup table for the correction values is Table 1 and Table 2 explained above. If the integrated value is for R, B and G, the correction values can be obtained based on Table 2. If the integrated value is for the color difference signal, the correction values can be obtained based on Table 1.

The method and the apparatus for generating the control signals to regulate gain levels of color signals according to an embodiment of the present invention enables to achieve the white balance control with high accuracy.

While the exemplary embodiments of the present invention have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the invention.

What is claimed is:

1. A method for generating control signals which regulate gain levels of a plurality of color signals to maintain white balance of an object by receiving image data comprising the plurality of color signals from the object and regulating the gain levels of the plurality of color signals, the method comprising the steps of:
generating first control signals to regulate the gain levels of the plurality of color signals based on a plurality of color signals of which gain levels are not regulated;
calculating correction values to correct the first control signals based on a plurality of color signals of which gain levels are regulated; and
generating second control signals which are results of correcting the first control signals by the correction values.

2. The method of claim 1, wherein the second control signals are generated by subtracting the correction values from the first control signals.

3. The method of claim 1, wherein the correction values are calculated so that the plurality of color signals of which the gain levels are regulated, are placed on a blackbody radiation curve CBL formed by values obtained when a white object is captured under various color temperatures on a two dimensional plane, the two-dimensional plane having one axis of a ratio IR_{OUT}/IG_{OUT} of a green integrated value IG_{OUT} and a red integrated value IR_{OUT} and the other axis of a ratio IB_{OUT}/IG_{OUT} of the green integrated value IG_{OUT} and a blue integrated value IB_{OUT}.

4. The method of claim 1, wherein the correction values are calculated so that the plurality of color signals of which the gain levels are regulated, are placed on a blackbody radiation curve CBL formed by values obtained when a white object is captured under various color temperatures on a two-dimensional plane, the two-dimensional plane having one axis of a red color difference signal R−Y_{OUT} and the other axis of a blue color difference signal B−Y_{OUT}.

5. The method of claim 1, wherein the correction values are calculated in reference to a lookup table having correction values determined experimentally according to the plurality of color signals of which the gain levels are regulated.

6. The method of claim 5, wherein the correction values of the lookup table are determined experimentally according to values of red, green and blue.

7. The method of claim 5, wherein the correction values of the lookup table are determined experimentally according to values of a red color difference signal R−Y, a blue color difference signal B−Y and a luminance signal Y.

8. The method of claim 1, wherein the generation of the first control signals comprises sub-steps of:
dividing the image data into a plurality of regions and calculating a red integrated value IR_{IN}, a green integrated value IG_{IN} and a blue integrated value IB_{IN} by the plurality of regions;
calculating a ratio IR_{IN}/IG_{IN} of the green integrated value IG_{IN} and the red integrated value IR_{IN} and a ratio IB_{IN}/IG_{IN} of the green integrated value IG_{IN} and the blue integrated value IB_{IN};
selecting from the plurality of regions a certain region of which the calculated ratios are within a predetermined range;
calculating average values IR_{AV,IN}, IG_{AV,IN} and IB_{AV,IN} of the red integrated value IR_{IN}, the green integrated value IG_{IN} and the blue integrated value IB_{IN} with respect to the selected region; and
obtaining the first control signals Rg₁ and Bg₁ from the following equation when there is at least one selected region:
Rg₁=1/(IR_{AV,IN}/IG_{AV,IN})
Bg₁=1/(IB_{AV,IN}/IG_{AV,IN})
and setting the first control signals to previous first control signals when there is no selected region.

9. The method of claim 8, wherein the predetermined range comprises a blackbody radiation curve formed by values obtained when a white object is captured under various color temperatures on a two-dimensional plane, the two-dimensional plane having one axis of a ratio IR_{IN}/IG_{IN} of the green integrated value IG_{IN} and the red integrated value IR_{IN} and the other axis of a ratio IB_{IN}/IG_{IN} of the green integrated value IG_{IN} and the blue integrated value IB_{IN}.

10. The method of claim 1, wherein the first control signals comprise Rg₁ and Bg₁, the correction values comprise ΔR and ΔB and the second control signals comprise Rg₂ and Bg₂.

11. An apparatus for generating control signals which regulate gain levels of a plurality of color signals to maintain white balance of an object by receiving image data comprising the plurality of color signals from the object and regulating the gain levels of the plurality of color signals, the apparatus comprising:
means for generating first control signals to regulate the gain levels of the plurality of color signals based on a plurality of color signals of which gain levels are not regulated;
means for calculating correction values to correct the first control signals based on a plurality of color signals of which gain levels are regulated; and
means for generating second control signals which are results of correcting the first control signals by the correction values.

12. The apparatus of claim 11, wherein the means for generating the second control signals obtains the second control signals by subtracting the correction values from the first control signals.

13. The apparatus of claim 11, wherein the means for calculating the correction values calculates correction values so that the plurality of color signals of which the gain levels are regulated, are placed on a blackbody radiation curve CBL formed by values obtained when a white object is captured under various color temperatures on a two-dimensional plane, the two-dimensional plane having one axis of a ratio IR_{OUT}/IG_{OUT} of a green integrated value IG_{OUT} and a red integrated value IR_{OUT} and the other axis of a ratio IB_{OUT}/IG_{OUT} of the green integrated value IG_{OUT} and a blue integrated value IB_{OUT}.

14. The apparatus of claim 11, wherein the means for calculating the correction values calculates the correction values so that the plurality of color signals of which the gain levels are regulated are placed on a blackbody radiation curve CBL formed by values obtained when a white object is captured under various color temperatures on a two-dimensional plane, the two-dimensional plane having one axis of a color difference signal R−Y_{OUT} and the other axis of a color difference signal B−Y_{OUT}.

15. The apparatus of claim 11, wherein the means for calculating the correction values calculates the correction values in reference to a lookup table having correction values determined experimentally according to the plurality of color signals of which the gain levels are regulated.

16. The apparatus of claim 15, wherein the correction values of the lookup table are determined experimentally according to values of red, green and blue.

17. The apparatus of claim 15, wherein the correction values of the lookup table are determined experimentally according to values of a red color difference signal R−Y, a blue color difference signal B−Y and a luminance signal Y.

18. The apparatus of claim 11, wherein the first control signals comprise Rg₁ and Bg₁, the correction values comprise ΔR and ΔB and the second control signals comprise Rg₂ and Bg₂.
